(19) United States
(12) Patent Application Publication
(10) Pub. No.: US 2012/0146410 A1
(43) Pub. Date: Jun. 14, 2012

(54) POWER SUPPLY SYSTEM INCORPORATING STORAGE UNIT

(75) Inventor: CHIH-CHUNG SHIH, Tu-Cheng (TW)

(73) Assignee: HON HAI PRECISION INDUSTRY CO., LTD., Tu-Cheng (TW)

(21) Appl. No.: 13/111,972

(22) Filed: May 20, 2011

(30) Foreign Application Priority Data
Dec. 13, 2010 (TW) 99143574

(51) Int. Cl. H02J 3/38

(52) U.S. Cl. 307/23

(57) ABSTRACT

An exemplary power supply system includes a mains supply unit, a generator unit, a switch unit selectively connected to one of the mains supply unit and the generator unit, a heat dissipation unit connected to the switch unit, a storage unit connected to the switch unit through a control element, and a plurality of server units connected to the storage unit. The heat dissipation unit is also connected to the storage unit. When the mains supply unit is cut off, the switch unit is automatically switched to connect the generator unit with the storage unit. After the mains supply unit is cut off and before the generator unit starts to output power, the storage unit is controlled to operate to thereby energize the server units and the heat dissipation unit to work continuously.

### BACKGROUND

1. Technical Field

The present disclosure relates to power supply systems, and particularly, to a power supply system having a storage unit.

2. Description of Related Art

A typical power supply system for a data center includes a mains supply unit, a generator unit, and a switch unit connected between the mains supply unit and the generator unit. Several servers and a heat dissipation unit are connected to the switch unit. When the mains supply unit is in operation, the switch unit connects the servers and the heat dissipation unit to the mains supply unit to thereby power the servers and the heat dissipation unit. When the mains supply unit has an outage, the switch connects the servers and the heat dissipation unit to the generator unit, to thereby continue to energize the servers and the heat dissipation unit. Generally, there is a transition period after cutting the mains supply unit off and before starting the generator unit. In order to maintain continuous power supply to the servers, a standby power source is provided to power the servers during the transition period. Nevertheless, the standby power source is only connected to the servers and cannot energize the heat dissipation unit. Therefore, the heat dissipation unit is unable to dissipate heat from the servers in the transition period. The heat is liable to accumulate within the servers and cause the servers to operate slowly or even malfunction.

What is needed, therefore, is a power supply system which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a power supply system of an embodiment of the present disclosure.

FIG. 2 shows detailed connections of electrical structures of the power supply system of FIG. 1.

### DETAILED DESCRIPTION

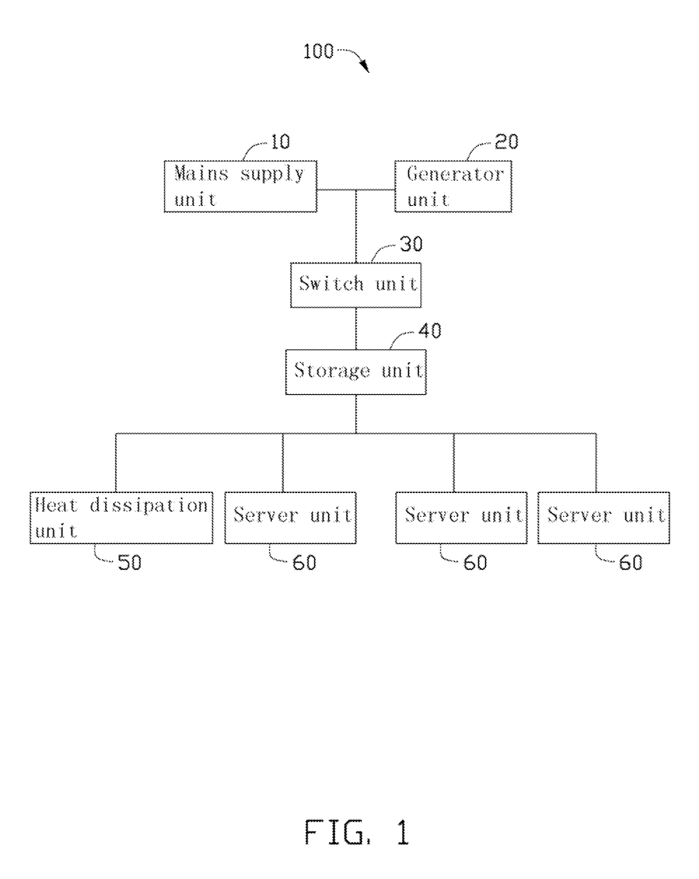

Referring to FIG. 1, a power supply system 100 in accordance with an embodiment of the present disclosure is shown. The power supply system 100 includes a mains supply unit 10, a generator unit 20, a switch unit 30, a storage unit 40, a heat dissipation unit 50 and a plurality of server units 60. The switch unit 30 is connected between the mains supply unit 10 and the generator unit 20. The storage unit 40 is connected to the switch unit 30. The server units 60 and the heat dissipation unit 50 are connected to the storage unit 40.

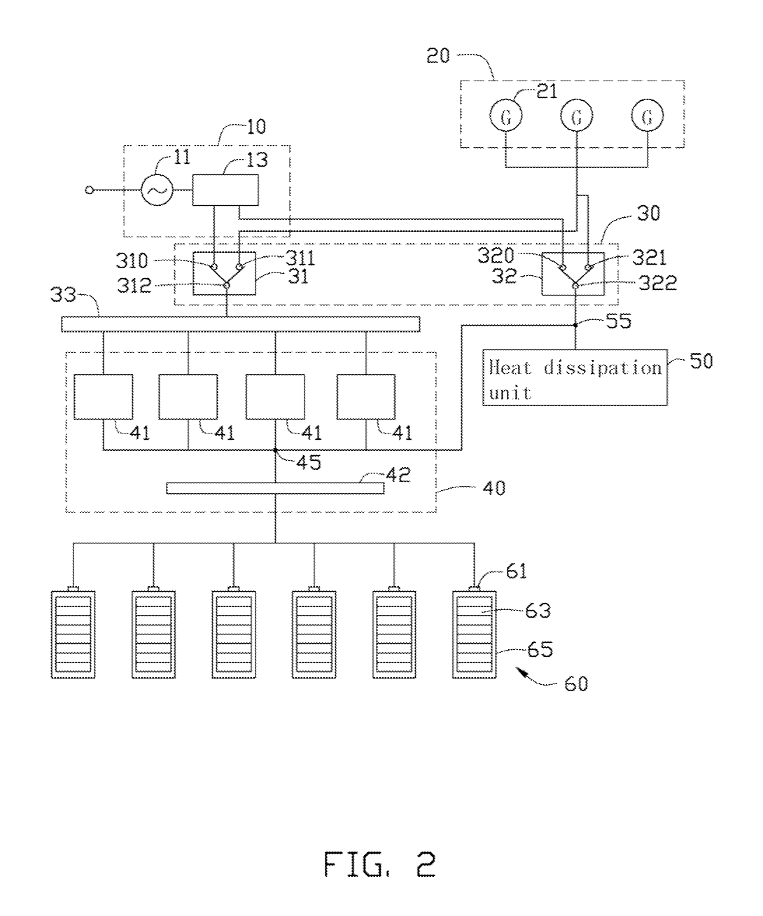

Also referring to FIG. 2, the mains supply unit 10 includes an AC (alternating current) source 11 and a transformer 13 connected to AC source 11. The generator unit 20 includes a plurality of generators 21. The switch unit 30 includes a first automatic transfer switch 31 and a second automatic transfer switch 32. The first automatic transfer switch 31 has two first contacts 310, 311 coupled with the mains supply unit 10 and the generator unit 20, respectively, and a second contact 312 connected to the storage unit 40 via a control element 33. The second automatic transfer switch 32 has two first contacts 320, 321 coupled with the mains supply unit 10 and the generator unit 20, respectively, and a second contact 322 connected to the heat dissipation unit 50. A first connection (or node) 55 is provided between the second contact 322 of the second automatic transfer switch 32 and the heat dissipation unit 50.

The storage unit 40 includes a plurality of uninterruptible power supplies 41, and a bypass switch 42 connected to the uninterruptible power supplies 41. The bypass switch 42 is used for allowing operators to maintain or repair the uninterruptible power supplies 41 without disconnecting the uninterruptible power supplies 41 from loads. Each server unit 60 includes a rack 65, a plurality of servers 63 stacked in the rack 65, and a power distribution unit 61 mounted to the rack 65 and connected to the servers 63. The uninterruptible power supplies 41 are connected to the power distribution units 61 via the bypass switch 42 to electrify the servers 63 of the server units 60. The bypass switch 42 and the uninterruptible power supplies 41 have a second connection (or node) 45 provided therebetween. The second connection 45 is electrically connected to the first connection 55.

When the mains supply unit 10 is in operation, the first contact 310 of the first automatic transfer switch 31 connects the second contact 312, and the first contact 311 is disconnected from the second contact 312; and the first contact 320 of the second automatic transfer switch 32 connects the second contact 322, and the first contact 321 is disconnected from the second contact 322. Therefore, the server units 60 and the heat dissipation unit 50 are energized by the mains supply unit 10 via the first automatic transfer switch 31 and the second automatic transfer switch 32. When the mains supply unit 10 is cut off, the second contact 312 of the first automatic transfer switch 31 is automatically disconnected from the first contact 310 and connected to the first contact 311; while the second contact 322 of the second automatic transfer switch 32 is automatically disconnected from the first contact 320 and connected to the first contact 312. Therefore, the generator unit 20 is switched to supply power to the server units 60 and the heat dissipation unit 50.

When the mains supply unit 10 or the generator unit 20 supplies power to the server units 60 and the heat dissipation unit 50, the storage unit 40 is charged by the mains supply unit 10 or the generator unit 20 via the control element 33. After an outage of the mains supply unit 10, a transition period begins and continues until the generator unit 20 starts to output power. Generally, the transition period lasts for about 15 minutes. During the transition period, the storage unit 40 is controlled by the control element 33 to operate, thereby providing power to the server units 60 and the heat dissipation unit 50. Therefore during the transition period, not only are the server units 60 powered to operate continuously, but also the heat dissipation unit 50 obtains power from the storage unit 40 to maintain its normal operation. The heat generated in the server units 60 is thus removed by the heat dissipation unit 50, and the servers 63 can operate safely within their normal temperature ranges.

It is believed that the present disclosure will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A power supply system comprising:
a mains supply unit;
a generator supply unit;
a switch unit;
a storage unit connected to the switch unit;
a server unit connected to the storage unit; and
a heat dissipation unit connected to the storage unit and the switch unit;
wherein the switch unit is switchable to selectively connect one of the mains supply unit and the generator unit with the server unit through the storage unit, the storage unit thereby being charged by the one of the mains supply unit and the generator unit; and
wherein during a transition period after the mains supply unit is disconnected from the switch unit and before the generator unit starts to supply power, the storage unit energizes the server unit and the heat dissipation unit to work.

2. The power supply system of claim 1, wherein the switch unit comprises a first automatic transfer switch and a second automatic transfer switch.

3. The power supply system of claim 2, wherein the first automatic transfer switch comprises two first contacts and a second contact, the second contact being selectively connected to either one of the two first contacts.

4. The power supply system of claim 3, wherein one of the two first contacts of the first automatic transfer switch connects the mains supply unit, the other one of the two first contacts of the first automatic transfer switch connects the generator unit, and the second contact of the first automatic transfer switch electrically connects the storage unit.

5. The power supply system of claim 4, wherein the second automatic transfer switch comprises two first contacts and a second contact, the second contact being selectively connected to either one of the two first contacts.

6. The power supply system of claim 5, wherein one of the two first contacts of the second automatic transfer switch is connected to the mains supply unit, the other one of the two first contacts of the second automatic transfer switch is connected to the generator unit, and the second contact of the second automatic transfer switch is connected to the heat dissipation unit.

7. The power supply system of claim 6, wherein the second contact of the second automatic transfer switch and the heat dissipation unit have a first connection formed therebetween, and the storage unit is electrically coupled with the first connection.

8. The power supply system of claim 6, wherein when the second contact of the first automatic transfer switch is connected to the one of the two first contacts of the first automatic transfer switch, and the second contact of the second automatic transfer switch is connected to the one of the two first contacts of the second automatic transfer switch, the mains supply unit is electrically connected to the storage unit and the generator unit is disconnected from the storage unit.

9. The power supply of claim 8, wherein when the second contact of the first automatic transfer switch is connected to the other one of the two first contacts of the first automatic transfer switch, and the second contact of the second automatic transfer switch is connected to the other one of the two first contacts of the second automatic transfer switch, the mains supply unit is disconnected from the storage unit and the generator unit is electrically connected to the storage unit.

10. The power supply system of claim 7, wherein the first automatic transfer switch is connected to the storage unit via a control element.

11. The power supply system of claim 10, wherein the storage unit comprises a plurality of uninterruptible power supplies connected to the control element, and a bypass switch connected to the uninterruptible power supplies.

12. The power supply system of claim 11, wherein the uninterruptible power supplies and the bypass switch have a second connection formed therebetween, the second connection being connected to the first connection.

13. The power supply system of claim 11, wherein the server unit comprises a rack, a plurality of servers mounted in the rack, and a power distribution unit connected to the servers, the bypass switch being connected to the power distribution unit.

14. A power supply system comprising:
a mains supply unit;
a generator unit;
a switch unit selectively connected to one of the mains supply unit and the generator unit;
a storage unit connected to the switch unit via a control element;
a heat dissipation unit connected to the switch unit and the storage unit; and
a server unit connected to the storage unit;
wherein the switch unit is automatically switchable to connect the generator unit when the mains supply unit has an outage; and
wherein the storage unit energizes the server unit and the heat dissipation unit when the mains supply unit and the generator unit do not supply power to the server unit and the heat dissipation unit.

15. The power supply system of claim 14, wherein the switch unit comprises a first automatic transfer switch and a second automatic transfer switch, each of the first automatic transfer switch and the second automatic transfer switch comprising two first contacts and a second contact selectively connected to any one of the two first contacts.

16. The power supply system of claim 14, wherein the second contact of each of the first automatic transfer switch and the second automatic transfer switch is disconnected from one of two corresponding first contacts and connected to the other one of the two corresponding first contacts when the mains supply unit is in outage.

17. The power supply system of claim 15, wherein the storage unit comprises a plurality of uninterruptible power supplies and a bypass switch connected to the uninterruptible power supplies, the control element being connected to the uninterruptible power supplies and the server unit being connected to the bypass switch.

18. The power supply system of claim 17, wherein the second contact of the second automatic transfer switch and the heat dissipation unit have a first connection formed therebetween, and the uninterruptible power supplies and the bypass switch have a second connection formed therebetween, the first connection being connected to the second connection.

19. The power supply system of claim 17, wherein the server unit comprises a rack, a plurality of servers mounted in the rack, and a power distribution unit connected to the servers, the power distribution unit being connected to the bypass switch.

20. The power supply system of claim 14, wherein the mains supply unit comprises an alternating current source and a transformer connecting the alternating current source, and the generator unit comprises a plurality of generators.
